(19) United States
(12) Patent Application Publication
(10) Pub. No.: US 2012/0128365 A1
(43) Pub. Date: May 24, 2012

(54) APPARATUS AND METHOD FOR PERFORMING COMMUNICATION USING LIGHT WAVELENGTHS IN A VISIBLE LIGHT COMMUNICATION SYSTEM

(75) Inventors: Dong Hwa PAEK, Seoul (KR); Dong Hun SEO, Suwon-si (KR)

(73) Assignee: PANTECH CO., LTD., Seoul (KR)

(21) Appl. No.: 13/106,033

(22) Filed: May 12, 2011

(30) Foreign Application Priority Data
Nov. 22, 2010 (KR) 10-2010-0116256

(51) Int. Cl. H04B 10/00

(52) U.S. Cl. 398/118

(57) ABSTRACT

A transmitting apparatus includes a controller to classify data to be transmitted and to select a corresponding wavelength, a signal modulator to encode the data into an electrical signal, and a light emitting unit to emit a visual light at the selected wavelength based on the electrical signal. A receiving apparatus includes a controller to classify data to be received, and to select a corresponding wavelength, an optical filter to receive and filter a visible light, a visible light receiver to transform the filtered visible light into an electrical signal, and a signal demodulator to demodulate the electrical signal into digital data. A transmission method includes classifying transmission data, selecting corresponding wavelength, and encoding the data into an electrical signal to transmit. A receiving method includes filtering a received light, transforming the filtered light into an electrical signal, and demodulating the transformed electrical signal into digital data.

### CROSS-REFERENCE TO RELATED APPLICATION

This application claims priority from and the benefit under 35 U.S.C. §119(a) of Korean Patent Application No. 10-2010-0116256, filed on Nov. 22, 2010, which is incorporated by reference for all purposes as if fully set forth herein.

### BACKGROUND OF THE INVENTION

1. Field

Exemplary embodiments of the present invention relates to a visible light communication, and more particularly, to an apparatus and a method that may provide a plurality of physical channels using a wavelength of light.

2. Discussion of the Background

Light Emitting Diode (LED) has become more common in the market place, providing lighting in portable devices, automobiles, traffic lights, billboards, fluorescent lamps, incandescent lamps, and the like. Due to the wide array of use of the LED technology, depletion of Radio Frequency (RF) band resources, the possibility of interference between many wireless communication technologies, an increasing demand for a communication security, the introduction of a broadband-ubiquitous communication environment of fourth generation (4G) wireless technology, and the like; an interest an optical wireless technology complementary to a RF technology has recently increased, and research on a Visible Light Communication (VLC) technology using a visible light LED is being carried out.

The VLC technology refers to a communication technology that transmits information using a visible light. Generally, in VLC technology, data may be transmitted by a method of modulating a visible light at a reference frequency emitted from a device having an LED, such as a lighting device, a display device, or the like. The VLC technology may not use an allocated frequency, and may enable a rapid transmission of a large amount of data using a rapid flicker.

The VLC technology may transmit information using a visible light, which may be safe, widely applicable, and freely available without regulation. In addition, since the VLC technology may identify a place where a light reaches or a moving direction of the light, the VLC technology may accurately determine a reception range of information.

Generally, the VLC technology communicates by allocating, to a single physical channel, a light emitted from a single LED or a LED Array, which may be efficient in a one-to-one communication. However, in a communication environment where multiple receivers may be available, the VLC may not efficiently communicate using a single physical channel.

### SUMMARY

Exemplary embodiments of the present invention provide a transmission and reception apparatus to perform communication using a wavelength of light in a visible light communication system. Exemplary embodiments of the present invention also provide a method for performing a communication using a wavelength of light in a visible light communication system.

Additional features of the invention will be set forth in the description which follows, and in part will be apparent from the description, or may be learned by practice of the invention.

Exemplary embodiment of the present invention provide a transmission apparatus to transmit data using a wavelength of light in a visible communication system including a controller to classify data to be transmitted, and to select a wavelength corresponding to the data classification; a signal modulator to encode the data to be transmitted into an electrical signal; a light emitting unit to emit a visual light at the selected wavelength based on the electrical signal; and a light emission controller to control the light emitting unit.

Exemplary embodiment of the present invention provide a reception apparatus to receive data using a wavelength of light in a visible communication system including a controller to classify data to be received, and to select a wavelength corresponding to the classification of the data to be received; an optical filter to receive a visible light, and to filter the received visible light using the selected wavelength; a visible light receiver to transform the filtered visible light corresponding to the selected wavelength into an electrical signal; and a signal demodulator to demodulate the electrical signal into digital data.

Exemplary embodiment of the present invention provide a reception apparatus to receive data using a wavelength of light in a visible communication system including an optical filter to filter a received visible light according to its wavelength, a visible light receiver to transform the filtered visible light to an electrical signal, and a signal demodulator to demodulate the transformed electrical signal into digital data, if the data exists in the transformed electrical signal.

Exemplary embodiment of the present invention provide a method for transmitting data using a wavelength of light in a visible light communication system including classifying a characteristic of data to be transmitted, selecting a wavelength corresponding to the data classification, encoding the data to be transmitted into an electrical signal, and emitting a visible light at the selected wavelength based on the electrical signal.

Exemplary embodiment of the present invention provide a method for receiving data using a wavelength of light in a visible light communication system including classifying data to be received and selecting a wavelength corresponding to the classification of the data to be received, receiving a visible light and filtering the received visible light using the selected wavelength, transforming the filtered visible light corresponding to the selected wavelength into an electrical signal, and demodulating the electrical signal into digital data.

Exemplary embodiment of the present invention provide a method for receiving data using a wavelength of light in a visible light communication system including filtering a received visible light according to its wavelength, transforming the filtered visible light into an electrical signal, and demodulating the transformed electrical signal into digital data, if the data exists in the transformed electrical signal.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a structure of a transmission apparatus that may transmit data using a wavelength of light in a visible light communication system according to an exemplary embodiment of the invention.

FIG. 2 is a diagram illustrating a structure of a reception apparatus that may receive data using a wavelength of light in a visible light communication system according to an exemplary embodiment of the invention.

FIG. 3 is a flowchart illustrating a process of transmitting data using a wavelength of light in a transmitting apparatus of a visible light communication system according to an exemplary embodiment of the invention.

FIG. 4 is a flowchart illustrating a process of receiving data using a wavelength of light in a receiving apparatus of a visible light communication system according to an exemplary embodiment of the invention.

FIG. 5 is a flowchart illustrating a process of receiving data using a wavelength of light in a receiving apparatus of a visible light communication system according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these exemplary embodiments are provided so that this disclosure will be thorough and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

According to embodiments of the present invention, there may be provided in a visible light communication system an apparatus and a method for providing a service appropriate for a characteristic of each of the at least one emission wavelength band.

A Light Emitting Diode (LED) may emit various types of white lights including a pseudo white, a brilliant white, and a three-wavelength white, that is, a LED combination of a red color, a green color, and a blue color. In an example, the pseudo white light may have wavelengths of 465 nm and 560 nm, brilliant white light may have wavelengths of 465 nm, 560 nm, and 620 nm, and the three-wavelength white light may have wavelengths of 465 nm, 530 nm, and 612 nm. Different services suitable to a characteristic of each of the multiple wavelengths may be provided using several emission wavelengths that may be emitted in a visible light produced by the LED.

Hereinafter, a service suitable to a characteristic of the wavelength will be described separately for each wavelength below. The specific wavelengths and its ranges are provided for the convenience of disclosure, and the present invention is not limited thereto.

First, a wavelength ranging between 610 nm and 700 nm corresponding to a red color may have a characteristic of having lower data transmission speed compared to a blue color emission wavelength, but the red color may also have a characteristic of having a low data loss during data transmission enabling a long distance transmission. Accordingly, the red color emission wavelength may provide a service channel to ensure high level of accuracy and reliability in its information delivery. More specifically, the red color emission wavelength may provide a service channel to “high accuracy data” and “high reliability data.” In an example, the red color emission wavelength may be used to transmit advertising information, goods management information, position information of a mobile device, authentication information, payment information, and the like.

A wavelength ranging between 400 nm and 450 nm corresponding to a blue color may have a characteristic of transmitting large amount of data at high speed compared to the red color emission wavelength. Accordingly, the blue color wavelength may provide a service channel to ensure high speed data transmission in its information delivery. More specifically, the blue color emission wavelength may provide a service channel to a “high speed transmission data.” In an example, such a service channel may be used as a multimedia service channel. Accordingly, the blue color emission wavelength may be used to stream an image and voice content, a file transmitting and receiving service of data files are larger than a reference size, and the like.

A wavelength ranging between 550 nm and 570 nm, which may be located between the red color and the blue color, corresponding to a green color may be used to provide general network service, which may be less concerned with the accuracy or the speed of data transmission. In an example, if the data file to be transmitted is determined not to be a high speed transmission data, a high accuracy data, or a high reliability data, then the green color emission wavelength may be provide a general network service to transmit the data. More specifically, the green color emission wavelength may provide a service channel to a “general transmission data.” Accordingly, the green color emission wavelength may be used to provide a network service between devices connected with the visible light communication technology.

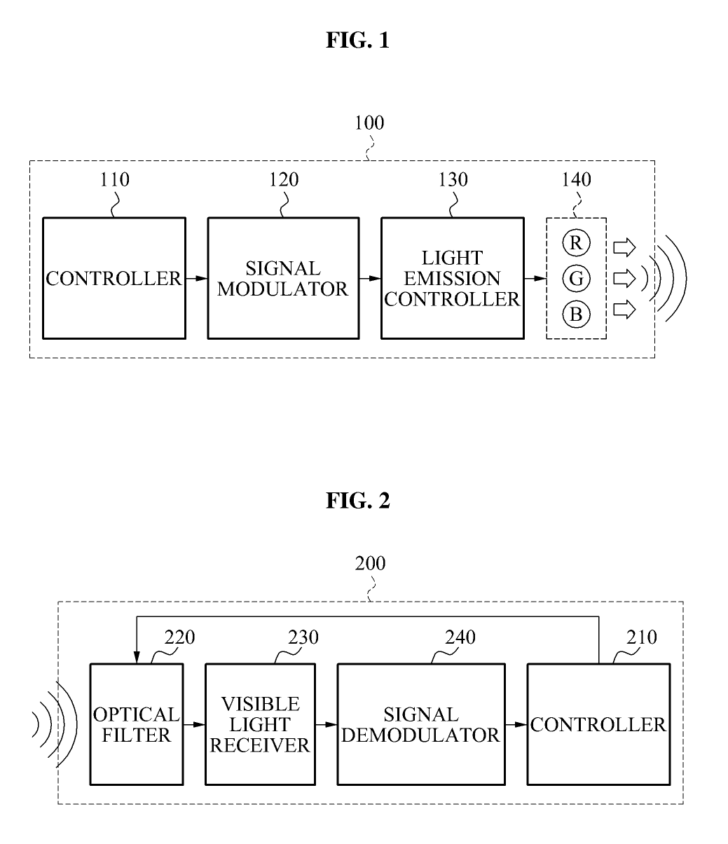

FIG. 1 is a diagram illustrating a structure of a transmission apparatus that may transmit data using a wavelength of light in a visible light communication system according to an exemplary embodiment of the invention.

As shown in FIG. 1, a transmission apparatus 100 includes a controller 110, a signal modulator 120, a light emission controller 130, and a light emitting unit 140.

The controller 110 may classify data to be transmitted and select a wavelength corresponding to the classified data to be transmitted. In an example, the data to be transmitted may be classified based on a level of accuracy or reliability of information delivery, speed of data transmission, or other similar criteria.

Based on the classification of the data to be transmitted, the controller 110 may select the wavelength that may transmit the identified data. More specifically, the controller 110 may select a wavelength corresponding to a red color to transmit the data, if the data to be transmitted is classified as a high accuracy data or a high reliability data. In an example, the data to be transmitted using the wavelength corresponding to the red color may include emergency notification information, advertising information, goods management information, position information of a mobile device, authentication information, or payment information.

In addition, the controller 110 may select a wavelength corresponding to a blue color for the classified data, if the data to be transmitted is classified as a high speed transmission data. In an example, the controller 110 may classify the data to be transmitted as a high speed transmission data due to the size or the type of the data to be transmitted, such as a streaming video file. In an example, the data to be transmitted using the wavelength corresponding to the blue color may include a voice data, image data, video data, or file data with a data size that may be greater than a reference value.

The controller 110 may select a wavelength corresponding to a green color, if the data to be transmitted is classified as a general transmission data. In an example, general transmission data may be data which may not be a high accuracy data, a high reliability data, or a high speed transmission data. Further, the data to be transmitted using the wavelength corresponding to a green color may include data to be transmitted and received over a network if a network service is provided. Such data may include messages that may be provided through an online chatting service, email, and the like.

The signal modulator 120 may encode the data to be transmitted into an electrical signal.

The light emission controller 130 may control the light emitting unit 140 that may emit a visible light of the selected wavelength to transmit a color corresponding to the wavelength that includes the encoded electrical signal.

The light emitting unit 140 may emit a light for each color corresponding to the wavelength under the control of the light emission controller 130.

FIG. 2 is a diagram illustrating a structure of a reception apparatus that may receive data using a wavelength of light in a visible light communication system according to an exemplary embodiment of the invention.

As shown in FIG. 2, a reception apparatus 200 includes a controller 210, an optical filter 220, a visible light receiver 230, and a signal demodulator 240.

The controller 210 may classify a data to be received and may further select a wavelength corresponding to the classification of the data to be received. In an example, the data to be received may be classified as a high accuracy data, a high reliability data, high speed transmission data, or a general transmission data.

The controller 210 may select a wavelength corresponding to a red color as a corresponding wavelength if the data to be received is classified as a high accuracy data or a high reliability data. In an example, the data to be received using the wavelength corresponding to the red color may include advertising information, goods management information, position information of a mobile device, authentication information, or payment information.

The controller 210 may select a wavelength corresponding to a blue color, if the data to be received is classified as a high speed transmission data. In an example, the data to be received using the wavelength corresponding to the blue color may include high speed transmission data, such as large data files. Large data files may include a voice data, image data, or file data with a data size that may be greater than a reference data size.

The controller 210 may select a wavelength corresponding to a green color, if the data to be received is classified as a general transmission data. In an example, the data to be received using the wavelength corresponding to the green color may include data to be transmitted and received over a network if a network service is provided.

The optical filter 220 may receive a visible light and filter the received visible light using the selected wavelength. More specifically, the received visible light may be filtered into range of wavelengths corresponding to a red light, a blue light, or a green light.

The visible light receiver 230 may transform the data included in the filtered wavelength into an electrical signal.

The signal demodulator 240 may demodulate the transformed electrical signal into digital data.

In addition, the controller 210 may control the reception apparatus 200 to receive data using all the wavelengths. In an example, the controller 210 may control reception apparatus 200 to receive data without specifying the data to be received based on a corresponding service.

In an example, if the data are received using all of the available wavelengths, the optical filter 220 may filter the received visible light for each wavelength. The visible light receiver 230 may transform the filtered visible light into an electrical signal. If the signal demodulator 240 determines that the transformed electrical signal includes transmitted data, the signal demodulator 240 may demodulate the transformed electrical signal into digital data.

A method of transmitting and receiving data using a wavelength of light in a visible light communication system is described more fully hereinafter with reference to the accompanying drawings.

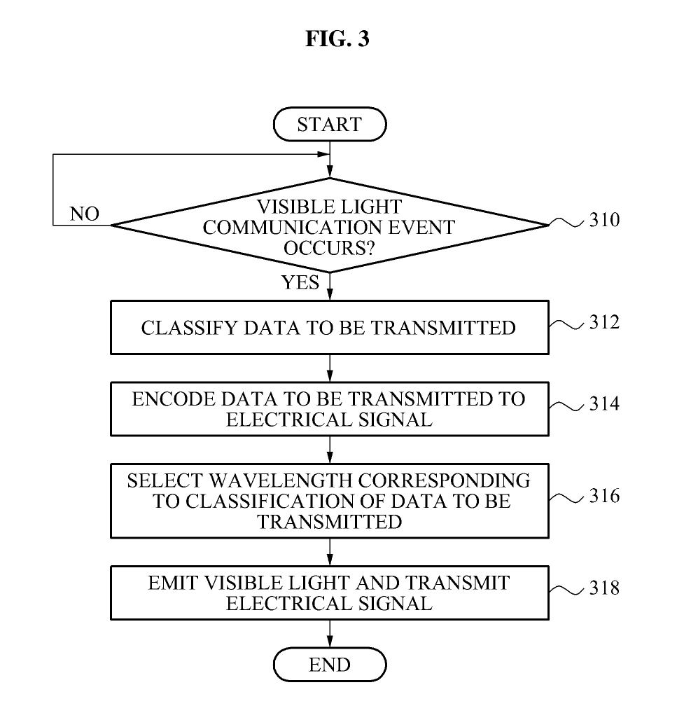

FIG. 3 is a flowchart illustrating a process of transmitting data using a wavelength of light in a transmitting apparatus of a visible light communication system according to an exemplary embodiment of the invention. For convenience, FIG. 3 will be described as if the method was performed by the transmission apparatus described above. However, the method is not limited as such.

Referring to FIG. 3, if detecting an occurrence of a visible light communication event in operation 310, the transmission apparatus 100 may classify a data to be transmitted in operation 312. In an example, the visible communication event may include a command inputted by a user to transmit data to a receiver, or an automated request to transmit data provided by a third party. The data to be transmitted may be classified as a high accuracy data, high reliability data, high speed transmission data, or a general transmission data based on its characteristics.

Next, the transmission apparatus 100 may encode the data to be transmitted into an electrical signal in operation 314. Then, the transmission apparatus 100 may select a wavelength corresponding to the classification of the data to be transmitted in operation 316.

More specifically, in operation 316, if the data to be transmitted is classified as a high accuracy data or a high reliability data, the transmission apparatus 100 may select the wavelength corresponding to a red color to transmit the data. Alternatively, if the data to be transmitted is classified as a high speed transmission data, the transmission apparatus 100 may select the wavelength corresponding to a blue color to transmit the data. On the other hand, if the data to be transmitted is classified as a general transmission data, the transmission apparatus 100 may select the wavelength corresponding to a green color to transmit the data.

The transmission apparatus 110 may emit a visible light of the identified wavelength and transmit the data through the selected wavelength in operation 318.

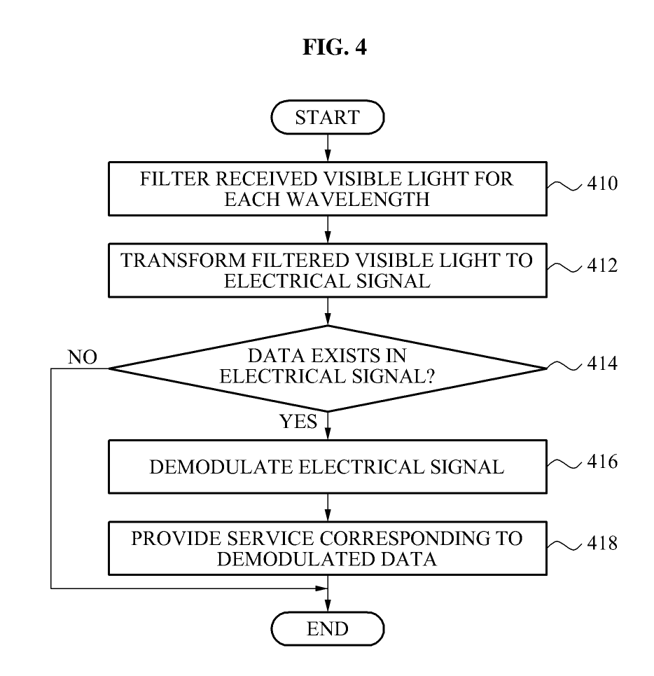

FIG. 4 is a flowchart illustrating a process of receiving data using a wavelength of light in a receiving apparatus of a visible light communication system according to an exemplary embodiment of the invention. For convenience, FIG. 4 will be described as if the method was performed by the reception apparatus described above. However, the method is not limited as such.

Referring to FIG. 4, the reception apparatus 200 receives the visible light and filters the received light for each wavelength in operation 410. In an example, the received visible light may be filtered according to wavelengths corresponding to the colors of red, blue, and green. Next, the reception apparatus 200 transforms the filtered visible light into an electrical signal in operation 412.

The reception apparatus 200 checks whether data exists in the transformed electrical signal in operation 414. Alternatively, although not illustrated, the reception apparatus 200 may check whether data exists in the filtered wavelengths before transforming the filtered visible light into electrical signals.

As a result of operation 414, if the data is determined to exist in the transformed electrical signal, the reception apparatus 200 may demodulate the transformed electrical signal into digital data in operation 416. In an example, the reception apparatus 200 may receive data using at least two wavelengths. Alternatively, if no data is determined to exist in the transformed electrical signal in operation 414, the process will terminate.

The reception apparatus 200 may then provide a user with a service corresponding to the demodulated data in operation 418. For example, if one of the transmitted data is an image file, the reception apparatus 200 may display the received image to the user.

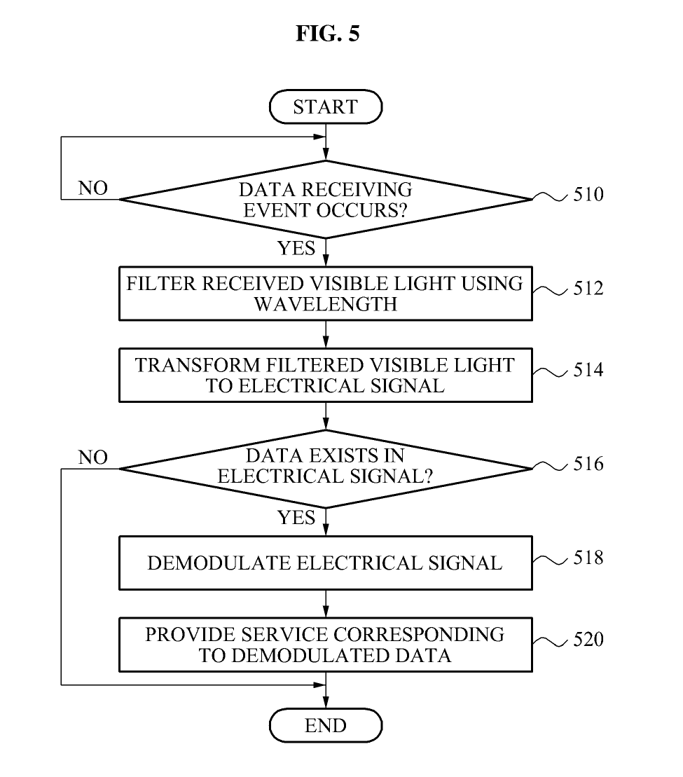

FIG. 5 is a flowchart illustrating a process of receiving data using a wavelength of light in a receiving apparatus of a visible light communication system according to an exemplary embodiment of the invention. For convenience, FIG. 5 will be described as if the method was performed by the reception apparatus described above. However, the method is not limited as such.

Referring to FIG. 5, if a data receiving event is detected using a visible light communication in operation 510, the reception apparatus 200 receives a transmitted visible light and filters the received visible light by determining the classification of the data to be received and the wavelength corresponding to the classification of data to be received in operation 512. In an example, data receiving event may include a request sent by the transmission apparatus 100 to receive the transmitted electronic signal, or a received input provided by a user to the reception apparatus 200.

More specifically, in operation 512, if the data to be received is classified as a high accuracy data or a high reliability data, the reception apparatus 200 may select the wavelength corresponding to a red color to be filtered. Alternatively, if the data to be received is classified as a high speed transmission data, the reception apparatus 200 may select the wavelength corresponding to a blue color to be filtered. On the other hand, if the data to be received is classified as a general transmission data, the reception apparatus 200 may select the wavelength corresponding to a green color to be filtered.

The reception apparatus 200 transforms the filtered wavelength into an electrical signal in operation 514. The reception apparatus 200 may further check whether data exists in the transformed electrical signal in operation 516.

Next, the reception apparatus 200 demodulates the transformed electrical signal into digital data in operation 518. The reception apparatus 200 provides a user with a service corresponding to the demodulated data in operation 520.

According to embodiments of the present invention, a transmission and reception apparatus and method may transmit and receive a wavelength corresponding to a data classification, which may be based on the characteristic of data to be transmitted and received in a visible light communication system. Further, the transmission and reception apparatus and method may select the wavelength as a separate physical communication channel, thereby providing a service corresponding to each wavelength.

The exemplary embodiments according to the present invention may be recorded in non-transitory computer-readable media including program instructions to implement various operations embodied by a computer. The computer-readable recording medium includes all kinds of recording devices storing data that is readable by a computer system. The computer-readable code may be executed by a computer having a processor and memory.

Examples of the computer-readable recording medium include read-only memories (ROMs), random-access memories (RAMs), (compact disc) CD-ROMs, magnetic tapes, floppy disks, optical data storage devices, and carrier waves (e.g., data transmission through the Internet). The computer-readable recording medium can be distributed over network connected computer systems so that the computer-readable code is stored and executed in a distributed fashion. Functional programs, code, and code segments needed for realizing the present invention can be easily deduced by computer programmers skilled in the art.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to transmit data using a wavelength of light in a visual light communication system, comprising:
a controller to classify data to be transmitted, and to select a wavelength corresponding to the data classification;
a signal modulator to encode the data to be transmitted into an electrical signal;
a light emitting unit to emit a visual light at the selected wavelength based on the electrical signal; and
a light emission controller to control the light emitting unit.

2. The apparatus of claim 1, wherein the data to be transmitted is classified as a high accuracy data, high reliability data, high speed transmission data, or a general transmission data.

3. The apparatus of claim 1, wherein, if the data to be transmitted is classified as a high accuracy data or a high reliability data, the controller selects a wavelength corresponding to a red color.

4. The apparatus of claim 3, wherein the data to be transmitted comprises at least one of advertising information, goods management information, position information of a mobile device, authentication information, and payment information.

5. The apparatus of claim 1, wherein, if the data to be transmitted is classified as a high speed transmission data, the controller selects a wavelength corresponding to a blue color.

6. The apparatus of claim 5, wherein the data to be transmitted comprises at least one of voice data, image data, and file data with a data size larger than a reference size.

7. The apparatus of claim 1, wherein, if the data to be transmitted is a general transmission data, the controller selects a wavelength corresponding to a green color.

8. The apparatus of claim 7, wherein if a network service is provided, the data to be transmitted corresponds to data to be transmitted over a network.

9. An apparatus to receive data using a wavelength of light in a visual light communication system, comprising:
a controller to classify data to be received, and to select a wavelength corresponding to the classification of the data to be received;
an optical filter to receive a visible light, and to filter the received visible light using the selected wavelength;
a visible light receiver to transform the filtered visible light corresponding to the selected wavelength into an electrical signal; and
a signal demodulator to demodulate the electrical signal into digital data.

10. The apparatus of claim 9, wherein, the data to be received is classified as a high accuracy data, a high reliability data, a high speed transmission data, or a general transmission data.

11. The apparatus of claim 9, wherein, if the data to be received is classified as a high accuracy data or a high reliability data, the controller selects a wavelength corresponding to a red color.

12. The apparatus of claim 9, wherein, if the data to be received is classified as a high speed transmission data, the controller selects a wavelength corresponding to a blue color.

13. The apparatus of claim 9, wherein, if the data to be received is classified as a general transmission data, the controller selects a wavelength corresponding to a green color as the identified wavelength.

14. An apparatus to receive data using a wavelength of light in a visual light communication system, comprising:
an optical filter to filter a received visible light according to its wavelength;
a visible light receiver to transform the filtered visible light into an electrical signal; and
a signal demodulator to demodulate the transformed electrical signal into digital data, if the data exists in the transformed electrical signal.

15. The apparatus of claim 14, wherein the wavelength corresponds to a classification of the received data; and wherein the data is classified as a high accuracy data, a high reliability data, a high speed transmission data, or a general transmission data.

16. A method for transmitting data using a wavelength of light in a visual light communication system, comprising:
classifying data to be transmitted;
selecting a wavelength corresponding to the data classification;
encoding the data to be transmitted into an electrical signal; and
emitting a visual light at the selected wavelength based on the electrical signal.

17. A method for receiving data using a wavelength of light in a visual light communication system, comprising:
classifying data to be received, and selecting a wavelength corresponding to the classification of the data to be received;
receiving a visible light, and filtering the received visible light using the selected wavelength;
transforming the filtered visible light corresponding to the selected wavelength into an electrical signal; and
demodulating the electrical signal into digital data.

18. A method for receiving data using a wavelength of light in a visual light communication system, comprising:
filtering a received visible light according to its wavelength;
transforming the filtered visible light into an electrical signal; and
demodulating the transformed electrical signal into digital data, if the data exists in the transformed electrical signal.
